(19) United States
(12) Patent Application Publication
(10) Pub. No.: US 2013/0346231 A1
(43) Pub. Date: Dec. 26, 2013

(54) SYSTEMS AND METHODS FOR OFFERING AND PURCHASING ITEM WITH MACHINE-READABLE LABEL

(71) Applicant: Worldwide Products Technology, Austin, TX (US)

(72) Inventor: Justin HISSONG, Arlington, TX (US)

(73) Assignee: Worldwide Products Technology

(21) Appl. No.: 13/924,290

(22) Filed: Jun. 21, 2013

Related U.S. Application Data
(60) Provisional application No. 61/662,583, filed on Jun. 21, 2012.

(51) Int. Cl. G06Q 30/06

(52) U.S. Cl. CPC G06Q 30/0635
USPC 705/26.5; 705/26.81

(57) ABSTRACT

A method of processing an order request for an item. The method includes offering, using a machine-readable label, the item to a customer, in response to receiving an indication that a mobile device has read the machine-readable label using a purchasing application, receiving, using a processor, customer information and the order request for the item from the mobile device, and processing the order request for the item using the customer information from the mobile device.

### CROSS-REFERENCE TO RELATED APPLICATION

This application claims priority from U.S. Provisional Application 61/662,583, filed on Jun. 21, 2012, in the United States Patent and Trademark Office, the disclosure of which is incorporated herein by reference.

### BACKGROUND

1. Field

Systems and methods consistent with the exemplary embodiments relate to purchasing an item, and more particularly, but not exclusively, to methods and systems for purchasing items having machine-readable labels associated with the items.

2. Description of the Related Art

Traditionally, when a consumer desires to order an item they have several options.

As a first option, the customer is required to take the following steps (in one order or another) leading to the acquisition of the desired item: (1) launch the website of their preferred vendor on a user device (e.g. laptop, mobile phone, etc.), (2) use the vendor's search facility to locate a list of items, (3) look through the search results and identify the item the consumer wishes to obtain, (4) select that item, (5) register on the vendor's website (for a first time customer) or enter log-in credentials (for a returning customer), (6) add the item to their virtual shopping cart, (7) in the case of a first time customer, enter shipping and billing information, and (8) make the final decision of whether or not to complete the order by clicking a button to order the item.

As a second option, the customer is required to take the following steps (in one order or another) leading to the acquisition of the desired item: (1) locate an item that they desire to acquire, (2) launch an application on their user device that allows the customer to scan a barcode on the desired item, (3) scan the barcode on the desired item, (4) receive a list of multiple vendors from which to purchase the desired item, (4) chose the desired vendor, (5) register on the vendor's website (for a first time customer) or enter log-in credentials (for a returning customer), (6) add the item to their virtual shopping cart, (7) in the case of a first time customer, enter shipping and billing information, and (8) make the final decision of whether or not to complete the order by clicking a button to order the item.

These options are quite laborious and are not highly effective at allowing a vendor to capitalize on a customer's impulsive purchasing decision. This is because the lengthy process gives the customer time to reconsider their decision to acquire the item.

### SUMMARY

One or more exemplary embodiments of the present disclosure may provide systems and methods completing a transaction at a time where the customer uses a mobile device to read a machine-readable code associated with the item. This may allow vendors to more effectively capitalize on a customer's impulsive purchasing decision.

According to an exemplary embodiment, a method of processing an order request for an item provided. The method includes offering, using a machine-readable label, the item to a customer, in response to receiving an indication that a mobile device has read the machine-readable label using a purchasing application: receiving, using a processor, customer information and the order request for the item from the mobile device; and processing the order request for the item using the customer information from the mobile device.

In an example embodiment, the method also includes in response to the mobile device reading the machine-readable label using an application other than the purchasing application: adding the item to a virtual shopping cart; and requesting a user of the mobile device to enter the customer information.

In yet another example embodiment, the method also includes offering the purchasing application to the customer in response to the mobile device reading the machine-readable label using an application other than the purchasing application.

In yet another example embodiment, the method also includes shipping the item to the consumer so that a size of the item corresponds to sizing information of the customer included in the customer information received from the mobile device.

In yet another example embodiment, the method also includes shipping the item using shipping information included in the customer information received from the mobile device.

In yet another example embodiment, the machine-readable label includes at least one of a Quick Response (QR) code, a bar code, a Radio Frequency Identification (RFID) tag, a geo-location tag, and a near-field communication (NFC) tag.

In yet another example embodiment the item includes digital media.

In yet another example embodiment, distributing the item to the customer includes permitting the customer to download the digital media.

In yet another example embodiment there is provided a customer system for obtaining an item. The customer system includes a memory configured to store customer information; a reading unit configured to read a machine-readable label; and a communication unit configured to transmit information to a server. In response to the reading unit reading the machine-readable label, the communication unit transmits the customer information and an order for the item to the server.

In yet another example embodiment the customer information includes a shipping location as a location to ship the item.

In yet another example embodiment the customer system includes a single-action mode, and in response to the customer system being in the single-action mode and the reading unit reading the machine-readable label, the communication unit transmits the customer information and the request to order the item to the server without further action by the customer system.

In yet another example embodiment, the customer system further includes a social network unit configured to post the machine-readable label read by the reading unit to a social network account.

In yet another example embodiment the customer information and the order for the item is all the information from the customer system that the server needs to complete the order.

In yet another example embodiment the customer information is stored in the memory prior to the reading unit reading the machine-readable label.

In yet another example embodiment the customer information includes credit card information, shipping information, and billing information.

In yet another example embodiment there is provided a server system. The server system includes a memory configured to store information associated with a machine-readable label, the information associated with the machine-readable label indicating an item associated with the machine-readable label; a communication unit configured to receive information from a customer system; an order receiving unit configured to receive a request to order the item in response to the communication unit receiving information indicating that the customer system read the machine-readable label using a purchasing application; and an order completing unit configured to complete an order the item in response to the order receiving unit receiving the request to order the item.

In yet another example embodiment the server system further includes a virtual shopping cart unit configured to place the item in a virtual shopping cart in response to the communication unit receiving information indicating that the customer system read the machine-readable label using an application other than the purchasing application.

In yet another example embodiment, completing the order for the item includes mailing the item to a customer using the information from the customer system.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1: shows an exemplary system for ordering items;

FIG. 2: shows an exemplary method of associating a machine-readable label with an item;

FIG. 3: shows an exemplary method of purchasing an item using the mobile device to read a machine-readable label;

FIG. 4: shows an exemplary method of selling an item; and

FIG. 5: shows an another exemplary system for ordering items.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

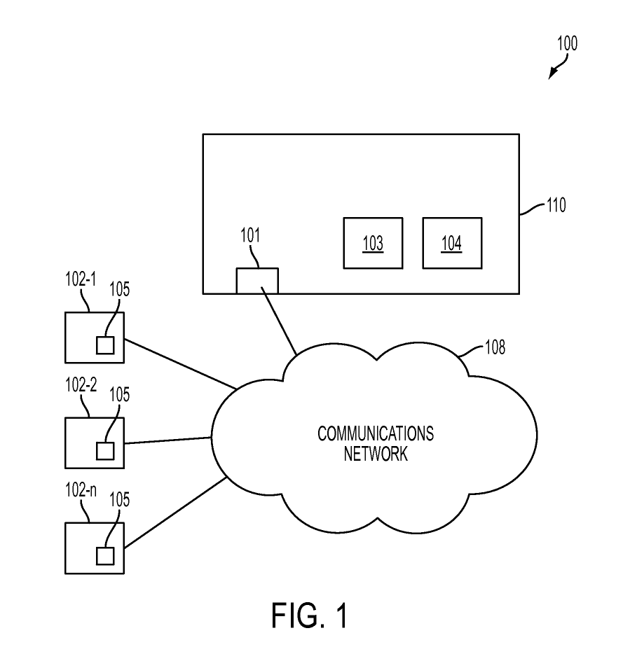

FIG. 1 shows an exemplary system 100 for ordering items. The system 100 includes a server 110, which includes a communications network interface 101, a memory 103, and a processor 104. The communication network interface 101 for communicating with a plurality of mobile devices 102-1, 102-2, and 102-n, using a communications network 108. The memory 102 for storing information input to the server 110 and the processor for processing information input to the server and executing software that is run by the server 110.

The communications network 108 may include the Internet, a cellular telecommunications system, a local/wide area network, a wireless network, a short-range wireless network, a combination of networks, etc.

The plurality of mobile devices 102-1 . . . 102-n, when not being individually referred to, are simply referred to as “the mobile device 102”. The mobile device 102 may be a device such as a cellular telephone, a tablet computer, a laptop computer, a handheld scanner, etc.

The mobile device 102 may include a memory 105 for storing a purchasing application for receiving and saving to the memory 105, customer information. The customer information may include information associated with the customer, such as, shipping information, billing information, sizing information, social network account information, location information, etc. The mobile device 102 may also store the customer information a cloud server (not shown) associated with the mobile device 102.

The purchasing application stored on the memory 105 is configured to read a machine-readable label. The machine-readable label may include, for example, at least one of a Quick Response (QR) code, a barcode, a Radio Frequency Identification (RFID) tag, a Near Field Communication (NFC) tag, a geo-location tag, etc.

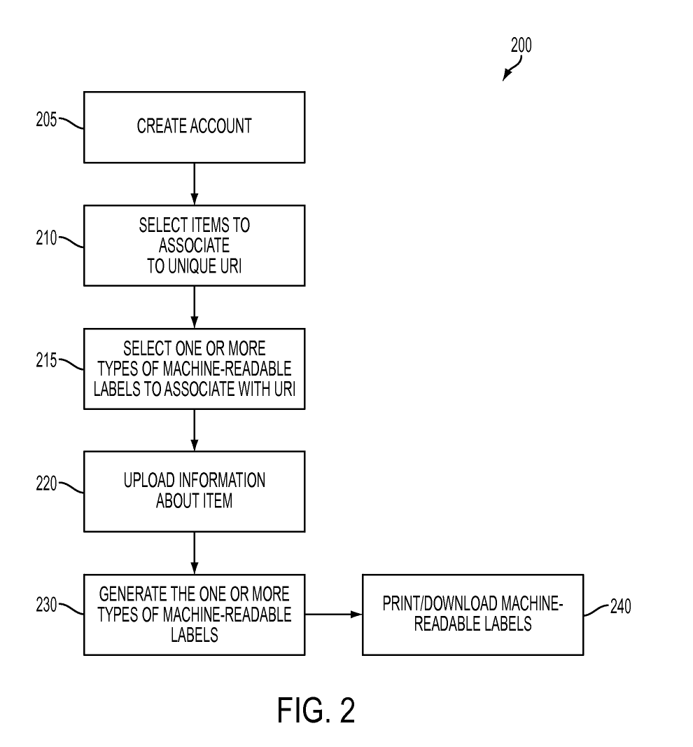

FIG. 2 shows an exemplary method 200 of associating a machine-readable label with an item. As used herein the term “item” may include a digital product (e.g., an MP3, a digital ticket, a digital magazine, a digital book, a digital game, a test, etc.), a tangible product (e.g., clothing, a ticket, an electronic device, food, a book, etc.), or both.

At 205, a vendor creates an account. This account may be hosted on the server 110. Creating an account, may include providing information such as a user identification, payment information, profile information, etc. At 210, the vendor selects one or multiple items to be associated to a particular uniform resource identifier (URI), for example, a t-shirt and/or a digital download. At 215, the vendor selects one or more types of machine-readable labels to associate with the particular URI. At 220, vendor uploads information about the item to the server 110. For example, the vendor may upload an image of the t-shirt and may upload the actual digital item. At 230, the vendor selects to generate the one or more types of machine-readable labels and the system generates the machine-readable labels associated with the particular URI. At 240, the vendor prints or downloads the machine-readable labels.

These machine-readable labels can be displayed to customers as part of a label associated with the item, in an advertisement, such as, a print advertisement or a digitally displayed advertisement, disposed on the item itself, etc.

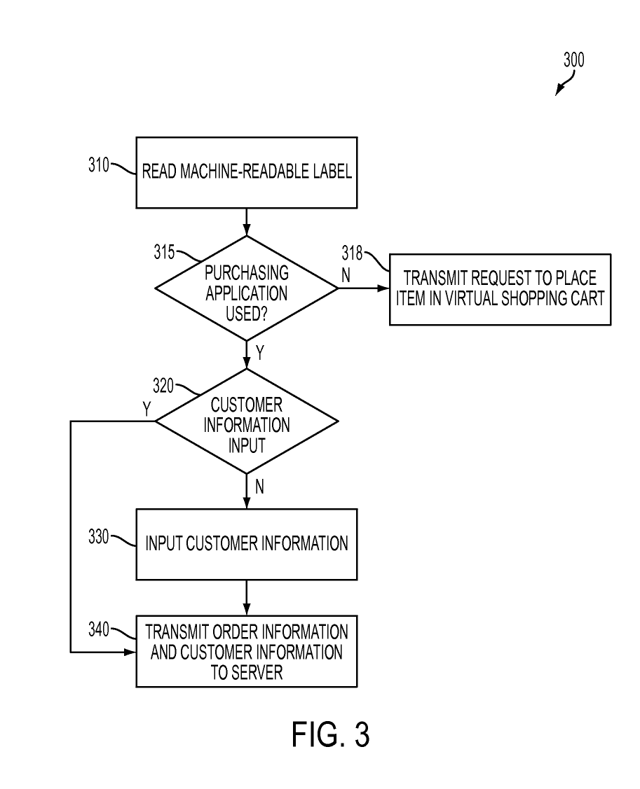

FIG. 3 shows a method 300 of purchasing an item by using the mobile device 102 to read a machine-readable label. As used herein the term “purchase” does not necessarily require an exchange of money, points, services, etc. For example, a customer can purchase a free/proportional item. By purchasing an item, the customer gains one or more rights associated with the item.

At 310, a customer uses the mobile device 102 to read a machine-readable label using the purchasing application. The purchasing application may cause a processor of the mobile device to execute a reading unit that is configured to read a machine-readable label. At 315 it is determined whether or not the purchasing application was used to read the machine-readable label. At 318, in a case where the machine-readable label is read with an application other than the purchasing application (N at 315), the item associated with machine-readable code and the URI is added to a virtual shopping cart, in which case a traditional purchasing process begins. Also, in another exemplary embodiment, in a case where the machine-readable label is read with an application other than the purchasing application (N at 315), the mobile device 102 accesses the URI but the item is neither automatically purchased nor added to a virtual shopping cart. That is, the server does not recognize that the machine-readable code has been read by the mobile device 102.

At 320, in a case where the machine-readable label is read with the purchasing application (Y at 315), the item is purchased. More specifically, in response to reading the machine-readable label, the purchasing application determines whether the necessary customer information has previously been input to (or received by) the purchasing application. The purchasing application may cause the processor of the mobile device to execute an input unit that is configured to have customer information input thereto. The customer information is stored on the memory 105 of the mobile device.

At 340, in response to determining that the necessary customer information has previously been input to (or received by) the purchasing application (Y at 320), the purchasing application communicates with the server 110 using the communication network 108 to complete the purchase.

The customer may not even be aware that the mobile device 102 has accessed the URI or that the mobile device is communicating with the server 110.

In some exemplary embodiments, the mobile device 102 may display a message indicating that a purchase of the item has been made. For example, the purchasing application may download and display the picture of the item, which the vendor uploaded to the server 110 and the customer just purchased, along with a message indicating that a purchase of the displayed item has been made.

At 330, in response to determining that the necessary customer information has not previously been input to (or received by) the purchasing application (N at 320), the purchasing application prompts the customer to input the necessary customer information needed to complete the purchase. The purchasing application stores this information in the memory 105, so that in any subsequent purchases the purchasing application can complete the purchase without further prompting the customer for additional information.

The purchasing application may also access other applications installed on the mobile device in order to acquire the necessary customer information. For example, if the machine-readable label read by the purchasing application is associated with a pair of shoes and the purchasing application does not know the shoe size of the customer, the purchasing application may interact with one or more other applications installed on the mobile device to obtain the shoe size of the customer. That is, if another application installed on the mobile device 102 has previously had the customer's shoe size input thereto and has saved this information, the purchasing application may obtain this information from the other application installed on the mobile device 102.

Similarly, if the billing or shipping information of the customer has not been input to the purchasing application, the purchasing application may access other applications installed on the mobile device 102 to obtain the billing or shipping information of the customer.

Once the customer information is obtained by the purchasing application, the purchasing application saves the customer information for future uses and causes the mobile device 102 to transmit an order request and the customer information to the server 110 using the communication network 108.

The order request is a request to order the item associated with the URI and the machine-readable label.

In a case where the mobile device 102 is unable to communicate with the sever 110 over the communication network 108, the purchasing application stores information associated with scanning the machine-readable label in a memory and periodically attempts to transmit the order request and customer information to the server 108 until the mobile device 102 is able to communicate with the server 110 over the communication network 108. Once the mobile device 102 is able to communicate with the sever 110 over the communication network 108, the purchasing application transmits the order request and the customer information to the server 108 over the communication network 108.

The purchasing application may include a purchase confirmation mode and a single-action mode. These modes may be set by the customer.

In the purchase confirmation mode, the customer is prompted to confirm that they wish to purchase the item that is associated with the machine-readable label read by the purchasing application.

In the single-action mode, the customer is not prompted to confirm that they wish to purchase the item that is associated with the machine-readable label read by the purchasing application. In a case where the necessary customer information is either already known by the purchasing application, or is able to be obtained from other applications installed on the mobile device 102, the simple action of reading the machine-readable code causes the purchasing application to execute a script to complete the purchase of the item associated with the machine-readable code without any further input by the customer.

On the other hand, in a case where the necessary customer information is not known by the purchasing application and is unable to be obtained by the purchasing application, the purchasing application prompts the customer to input the necessary customer information. In response to the necessary customer information being input, the purchasing application completes the purchase of the item without any further input by the customer.

The purchasing application may also include gift mode, which is also set by the customer. For example, the purchasing application may cause the processor of the mobile device to execute a gifting unit that is configured to give the purchased item to another person. In a case where the gift mode is activated and the customer uses the purchasing application to read a machine-readable label, the purchasing application prompts the customer to enter delivery information of the person for whom the gift is intended. For example, in a case where the gifted item is a digital item, the purchasing application may prompt the customer to enter the person's mobile telephone number, their e-mail address, their social network username, etc. In a case where the gifted item is a tangible item, the purchasing application may prompt the customer to enter the person's mailing address.

The purchasing application may also include social network sharing mode, which is also set by the customer. For example, the purchasing application may cause the processor of the mobile device to execute a social network unit that is configured to post the machine-readable label read by the reading unit to a social network account. In a case where the social network sharing mode is activated and the customer uses the purchasing application to read a machine-readable label, the purchasing application may post the machine-readable label to the customer's social networking account. This feature may allow the customer's friends and/or followers on the social networking site to also purchase the item simply by reading the machine-readable label posted to the customer's social networking account with their own mobile device 102 having the purchasing application installed thereon.

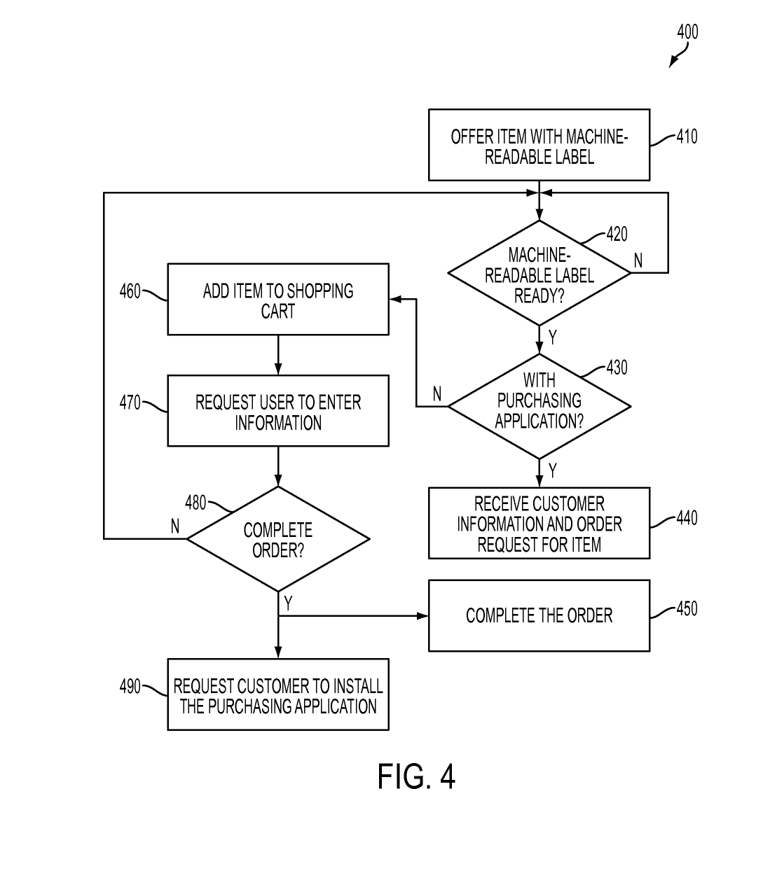

FIG. 4 shows a method 400 of selling an item. At 410 the item is offered to the customer using the machine-readable label. At 420 a determination of whether or not the machine-readable label has been read is made. This determination is made by ascertaining whether or not the mobile device 102 has attempted to access the URI associated with the machine-readable label.

In response to determining that the mobile device 102 has not read the machine-readable label (N at 420), the method 400 continues to wait for the mobile device 102 to read the machine-readable label.

In response to determining that the mobile device 102 has read the machine-readable code (Y at 420), another determination of whether or not the mobile device 102 read the machine-readable code using the purchasing application is made at 430.

At 440, the server 110 receives the customer information and the order request for the item from the mobile device 102 as a result of the mobile device 102 reading the machine-readable code using the purchasing application (Y at 430). For example, the server 110 may cause a processor to execute an order receiving unit that is configured to receive a request to order the item in response to receiving information indicating that the mobile device has read the machine-readable label using the purchasing application.

At 450, the server 110 processes the order of the item using the customer information and the order request for the item. For example, the server 110 may cause a processor to execute an order generating unit configured to order the item in response to receiving the request to order the item. Completing the processing the order of the item may include distributing the item to the customer in the case of a digital item. Also, in a case where the item is a tangible item, processing the order of the item may include generating a purchase receipt for the item and sending it to the mobile device 102 and/or an e-mail address associated with the customer. As described later, processing the order may include interfacing with a vendor's servers to confirm that the item is available to be shipped to the customer and alerting the vender that the customer has ordered the item.

As would be appreciated by one having ordinary skill in the art having read the instant disclosure, the above-mentioned features are highly effective at allowing a vendor to capitalize on a customer's impulsive purchasing decision. This is because the simple act of reading the machine-readable label is sufficient to cause the customer to purchase the item. Indeed, even in a case where the purchasing application is not set in the single action mode, the customer simply has to affirm that they wish to purchase the item. Since, this is not a laborious process, the customer is not likely to reconsider their purchasing decision before making the simple affirmation.

When compared to the above-mentioned traditional options for ordering an item, exemplary embodiments of the present disclosure are much simpler and less laborious. For example, according to an exemplary embodiment of the present disclosure, when a consumer desires to order an item they can simply (1) launch the purchasing application from the mobile device 102, and (2) use the purchasing application to read the machine-readable label associated with the item they wish to acquire and thereby complete the purchase of the desired item.

Indeed, even in a case where the purchasing application has not previously been inputted with the necessary customer information to complete the purchase, the purchasing application either acquires the necessary customer information from other applications installed on the mobile device 102 or requests the customer to enter the necessary customer information. After the customer has entered this information once, the customer is no longer required to enter the information because it is stored in the memory of the mobile device 102.

In an exemplary embodiment of the present disclosure, the purchasing application requests the customer to enter the customer information during an initial setup and thereafter the customer no longer needs to input any information to make purchases using the purchasing application.

On the other hand, in a case where the mobile device 102 reads the machine-readable code without using the purchasing application (N at 430), the ensuing purchasing experience is somewhat similar to a more traditional purchasing experience.

Specifically, at 460 the server 110 adds the item associated with the URI to a virtual shopping cart. For example, the server 110 may cause a processor to execute a virtual shopping cart unit configured to place the item in a virtual shopping cart in response to the server 110 receiving information indicating that the mobile device read the machine-readable label using an application other than the purchasing application.

At 470, the customer is requested to enter, into the mobile device, the necessary customer information needed to order the desired item. At 480, the customer is required to affirm that they wish to complete the other.

In response to the customer affirming that they wish to complete the order (Y at 480), the server 110 processes the order. In response to the customer failing to affirm that they wish to complete the order (N at 480), the method 400 returns to 420 and checks to see whether the machine-readable label has been read with the mobile device 102.

At 490, in addition, in a case where the mobile device 102 reads the machine-readable code without using the purchasing application (N at 430), the server 110 requests the customer to install the purchasing application on the mobile device 102 in order to complete the purchase. In response to the customer installing the purchasing application on the mobile device 102, the same process as that described above where the mobile device 102 reads the machine-readable code using the purchasing application (Y at 430) ensues.

In another exemplary embodiment of the present disclosure, a geo-location tag is used as the machine-readable label. In response to the mobile device 102 entering into a predetermined area set by the vendor, the server pushes requests to purchase an item to the mobile device 102. The customer can then accept or decline to purchase the item by interacting with the purchasing application.

For example, in a case where the vendor is a management company for a band, the vendor can set the predetermined area to be a certain proximity from a venue in which the band is playing or will play. When the mobile device 102, generally carried by the customer, enters into the predetermined area, the server can push a request to purchase a ticket to see the band or a request to purchase an MP3 of the band's music. The customer can simply accept or decline to acquire these items by interacting with the purchasing application.

In another exemplary embodiment of the present disclosure, the item is a digital item and completing the order at 450 of FIG. 4 includes sending, using the server 110, digital rights information to the purchasing application. According to this exemplary embodiment, the digital item may be accessed using the digital rights information sent to the purchasing application.

For example, in a case where the vendor is a university that wishes to administer a test to a student, the student may acquire the test by using the mobile device 102 to read a machine-readable label associated with the test. Upon acquiring the test, the purchasing application may open the test using the digital rights information sent to the purchasing application. The university may set, as part of the digital rights information a predetermined time frame for accessing the test following the purchase of the test by the student.

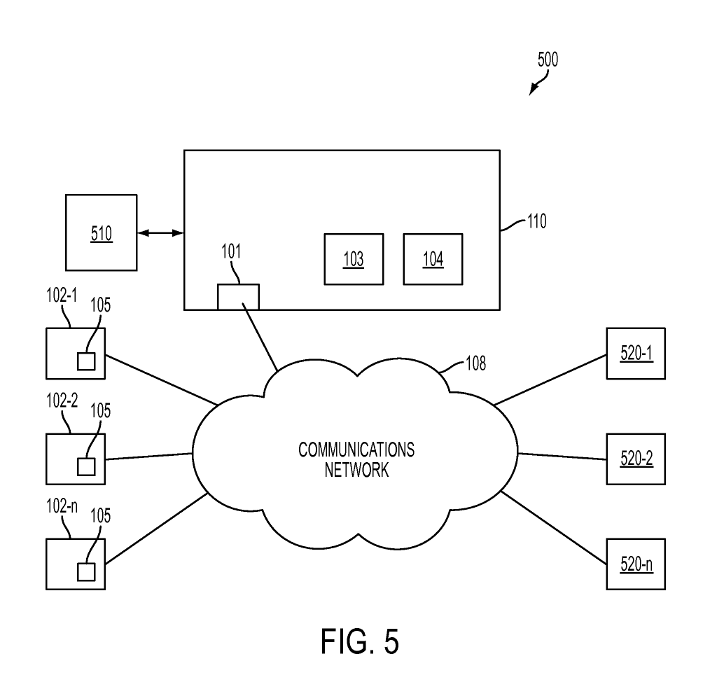

FIG. 5 shows an exemplary system 500 for ordering items. The system 500 includes the server 110, the mobile device 102, the communication 108, each of which had been previously described. Thus a duplicate discussion is omitted. The system 500 further includes an inventory management system 510. While the inventory management system is shown separate from the server 110, it may be executed by a processor on the server or may be executed by another processor separate from the server.

In this exemplary embodiment, the inventory management system 510 communicates, using the communications network 108, with inventory servers 520-1, 520-2, . . . 520-n, controlled by various vendors. The inventory management system 510 permits the server 110 to process order requests while the inventory server 520 associated with a particular item indicates that the vendor still has the item available. In response to the inventory server 520 indicating that the particular item is no longer available, the inventory management system prevents the server 110 from processing order requests for the particular item.

In response to the inventory management system 510 preventing the server 110 from processing order requests for the particular item the sever 110 communicates with the mobile device 102 so that the purchasing application notifies the customer that the purchase of the item cannot be completed.

In another exemplary embodiment, the vendor predetermines what will happen in a case when the inventory server 520 indicates that the particular item is no longer available. For example, the vendor send a message to the customer to indicate that the item is back ordered. Also, in a case where the item is made to order, the vendor may receive a message from the server 110 indicating that they have received an order. In response to receiving this message, the vendor can begin making the item. In the alternative, the inventory management system 510 may prevent the purchase as described above.

Although various exemplary embodiments have been described above, it is noted that there can be a variety of permutations and modifications of the described features by those who are familiar with this field, without departing from the technical ideas and scope of the features, which shall be defined by the appended claims.

Further, while this specification contains many exemplary features, the features should not be construed as limitations on the scope of the disclosure or the appended claims. Certain features described in the context of separate embodiments can also be implemented in combination. Conversely, various features described in the context of a single embodiment can also be implemented in multiple embodiments separately or in any suitable sub-combination.

What is claimed is:

1. A method of processing an order request for an item, the method comprising:
offering, using a machine-readable label, the item to a customer;
in response to receiving an indication that a mobile device has read the machine-readable label using a purchasing application:
receiving, using a processor, customer information and the order request for the item from the mobile device; and
processing the order request for the item using the customer information from the mobile device.

2. The method of processing an order request for an item according to claim 1, further comprising:
in response to the mobile device reading the machine-readable label using an application other than the purchasing application:
adding the item to a virtual shopping cart; and
requesting a user of the mobile device to enter the customer information.

3. The method of processing an order request for an item according to claim 1, further comprising offering the purchasing application to the customer in response to the mobile device reading the machine-readable label using an application other than the purchasing application.

4. The method of processing an order request for an item according to claim 1, further comprising shipping the item to the consumer so that a size of the item corresponds to sizing information of the customer included in the customer information received from the mobile device.

5. The method of processing an order request for an item according to claim 1, further comprising shipping the item using shipping information included in the customer information received from the mobile device.

6. The method of processing an order request for an item according to claim 1, wherein the machine-readable label includes at least one of a Quick Response (QR) code, a bar code, a Radio Frequency Identification (RFID) tag, a geo-location tag, and a near-field communication (NFC) tag.

7. The method of distributing an item according to claim 1, wherein the item includes digital media.

8. The method of distributing an item according to claim 7, wherein distributing the item to the customer includes permitting the customer to download the digital media.

9. A customer system for obtaining an item, the customer system comprising:
a memory configured to store customer information;
a reading unit configured to read a machine-readable label; and
a communication unit configured to transmit information to a server, wherein
in response to the reading unit reading the machine-readable label, the communication unit transmits the customer information and an order for the item to the server.

10. The customer system for purchasing an item according to claim 9, wherein the customer information includes a shipping location as a location to ship the item.

11. The customer system for purchasing an item according to claim 9, wherein the customer system includes a single-action mode, and
in response to the customer system being in the single-action mode and the reading unit reading the machine-readable label, the communication unit transmits the customer information and the request to order the item to the server without further action by the customer system.

12. The customer system for ordering an item according to claim 9, further comprising a social network unit configured to post the machine-readable label read by the reading unit to a social network account.

13. The customer system for ordering an item according to claim 9, wherein the customer information and the order for the item is all the information from the customer system that the server needs to complete the order.

14. The customer system for ordering an item according to claim 13, wherein the customer information is stored in the memory prior to the reading unit reading the machine-readable label.

15. The customer system for ordering an item according to claim 14, wherein the customer information includes credit card information, shipping information, and billing information.

16. A server system comprising:
a memory configured to store information associated with a machine-readable label, the information associated with the machine-readable label indicating an item associated with the machine-readable label;
a communication unit configured to receive information from a customer system;
an order receiving unit configured to receive a request to order the item in response to the communication unit receiving information indicating that the customer system read the machine-readable label using a purchasing application; and
an order completing unit configured to complete an order the item in response to the order receiving unit receiving the request to order the item.

17. The server system according to claim 16, further comprising:
a virtual shopping cart unit configured to place the item in a virtual shopping cart in response to the communication unit receiving information indicating that the customer system read the machine-readable label using an application other than the purchasing application.

18. The server system according to claim 13, wherein completing the order for the item includes mailing the item to a customer using the information from the customer system.
